(19) United States
(12) Patent Application Publication
(10) Pub. No.: US 2009/0212899 A1
(43) Pub. Date: Aug. 27, 2009

(54) Low Pressure Transducer Using Beam and Diaphragm

(75) Inventor: Chris Gross, Yorktown, VA (US)

Correspondence Address: Howard IP Law Group, P.O. Box 226, Fort Washington, PA, 19034, US

(73) Assignee: Measurement Specialties, Inc., Hampton, VA (US)

(21) Appl. No.: 12/394,999

(22) Filed: Feb. 27, 2009

Related U.S. Application Data
(60) Provisional application No. 61/031,897, filed on Feb. 27, 2008.

(51) Int. Cl. G01L 1/22; H01C 17/28; H01C 10/10

(52) U.S. Cl. 338/4; 29/621.1; 338/42

(57) ABSTRACT

A low-pressure transducer including a disc-shaped metal diaphragm to which a fluid pressure is applied, wherein the diaphragm contains a raised beam formed by thinning the entire exterior surface of the diaphragm except for the beam; and at least one silicon strain gage glass bonded to the beam, wherein the low-pressure transducer can accurately gage pressures at least as low as 15 psi. The present invention also comprises a method for manufacturing a pressure transducer including the steps of forming a cylindrical diaphragm having a top surface and a lower surface; establishing a diameter and a thickness of the diaphragm relative to an operational plane by a creating a hole axially through the transducer body that terminates at the lower surface; and creating a raised surface in the shape of a cross beam integral to the operational surface; and bonding one or more strain gages thereupon.

### CROSS REFERENCE TO RELATED APPLICATION

The present application claims the benefit of U.S. Provisional Application Ser. No. 61/031,897, entitled A LOW PRESSURE TRANSDUCER USING BEAM AND DIAPHRAGM, filed Feb. 27, 2008, which application is incorporated by reference herein in its entirety.

### FIELD OF THE INVENTION

The present invention relates to fluid pressure sensors and particularly to strain gage based pressure transducers.

### BACKGROUND

Strain gage based pressure transducers are used to measure pressures such as the pressure of fluids in a vehicle. These devices use a strain gage associated with a diaphragm in contact with a pressure source. Very thin metal diaphragms have been used to detect low level pressures. However, such thin metal diaphragms exhibit an undesirable interaction, affecting both sensitivity and accuracy caused by the difference in temperature coefficients of expansion of the silicon strain gage/glass structure and the metal. This is particularly problematic for dissimilar materials of glass bonded silicon strain gages and metal diaphragms operating in environments where temperatures range in the hundreds of degrees Fahrenheit (F). Differences in expansion coefficients create high strain levels between the strain gages and the metal diaphragm to which they are attached which in turn causes unreliable measurements.

These instabilities in pressure readings reduce the accuracy, particularly after temperature or pressure cycling. This undesirably constrains metal diaphragm gage applications to accurate pressure measurements of pressures greater than about 50 psi; or to those applications where measurements less than about 50 psi are required with less accuracy.

### SUMMARY OF THE INVENTION

An embodiment of the present invention is a low-pressure fluid transducer comprising: a cylindrical metal diaphragm to which a fluid pressure is applied, the metal diaphragm top surface having thereon a raised metal beam that crosses the diaphragm top surface; at least one silicon strain gage glass bonded to a top surface of the raised metal beam, wherein the fluid pressure deflects the diaphragm, producing a strain on the raised metal beam and the associated stain gage producing an electrical output indicative of the pressure. In this configuration, the integral raised metal beam and stain gages glass bonded thereto are capable of detecting a pressure several times lower than that which could be detected by a metal transducer having a flat metal diaphragm without the raised metal beam.

An embodiment of the present invention also comprises a method for manufacturing a pressure transducer including the steps of: forming in a metal transducer body a cylindrical metal diaphragm having a top surface and a lower surface; establishing a diameter and a thickness of the cylindrical metal diaphragm relative to an operational plane by creating a hole axially positioned through the transducer body that terminates at the lower surface of the diaphragm; forming from the metal diaphragm a raised surface in the shape of a beam integral to the operational surface of the diaphragm; and glass bonding one or more strain gages to the raised surface of the metal beam.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and in which:

FIG. 1 illustrates a low pressure transducer using a beam and diaphragm structure according to an aspect of the present invention;

FIG. 2 illustrates a top view of the structure of FIG. 1 according to an aspect of the present invention;

FIG. 3. illustrates a cross sectional view A-A of FIG. 2 according to an aspect of the present invention; and,

FIG. 4 illustrates a detailed view B of FIG. 3 according to an aspect of the present invention.

FIGS. 5a, 5b, and 5c illustrate perspective quarter sectional views of an exemplary pressure port transducer with central boss according to an embodiment of the invention.

FIG. 6a illustrates a sectional view of an exemplary bossed low pressure port transducer useful for implementing the present invention.

FIG. 6b illustrates a more detailed view a portion of the metal diaphragm portion of FIG. 6a.

FIG. 7 is a graph depicting strain radial distribution results associated with an embodiment of the present invention.

### DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical pressure sensing methods and systems. However, because such elements are well known in the art, and because they do not facilitate a better understanding of the present invention, a discussion of such elements is not provided herein. The disclosure herein is directed to all such variations and modifications known to those skilled in the art.

The present invention relates to a low pressure metal transducer that utilizes silicon strain gages glass bonded to a raised metal surface also referred to as a cross beam, which is formed from metal stock integral to a metal diaphragm formed from a cylindrical section. The ratio of the area of diaphragm top surface embodying the metal beam to the total area of the metal diaphragm top surface serves to amplify the force produced by fluid pressure on the lower surface or backside of the diaphragm. Integration of the beam and the diaphragm top surface diminishes the undesirable interaction between the bonded strain gage and the metal diaphragm that would otherwise occur in the prior art due at least in part to differences in temperature coefficients of expansion.

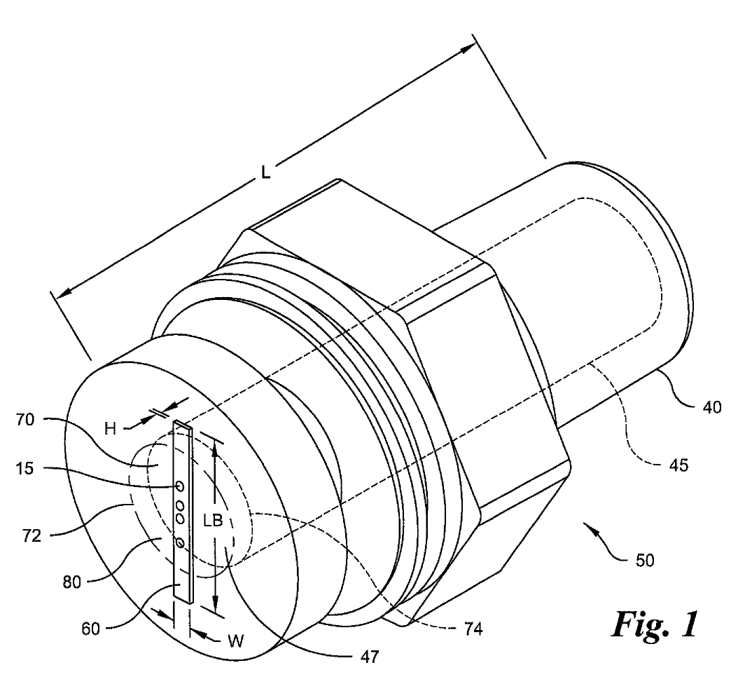

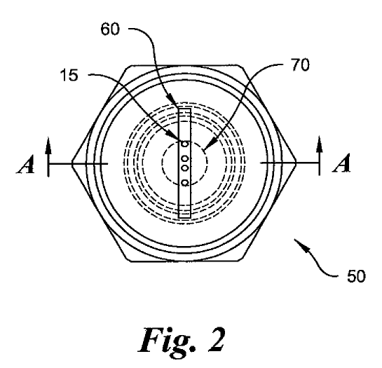

Referring to FIG. 1 in conjunction with FIG. 2, there is shown an embodiment of the present invention of a low-pressure metal transducer 50 comprising a metal cylindrical section that forms a circular, thinned metal diaphragm 70. The metal diaphragm has a diameter 72, a top surface 47 and a lower surface 74 opposite the top surface. A central bore hole 45 extends axially the length of the body of the transducer and terminates at the diaphragm lower surface 74. The top surface 47 forms the top of the transducer 50 and is integral to the metal housing 40. The metal diaphragm is preferably made from stainless steel and monolithically formed of the stainless steel body or metal stock of the housing 40.

Still referring to FIG. 1, raised metal surface of diaphragm 70 referred to as beam 60 extends from the top surface a predetermined distance (H) normal to the operational plane of the diaphragm, and has a length LB and width (W) along the respective axes. In one embodiment the height, length and the width of the beam 60 is obtained by removing metal material from the top surface of the diaphragm such that the initial thickness of the diaphragm of transducer 50 is reduced in the plane of the operational top surface 47 (e.g. from that of a conventional flat diaphragm transducer), except for the location of the beam 60. The beam 60, diaphragm 70, and housing body 40 form an integrated or monolithic unit.

The thickness of the diaphragm is reduced except in the area defined by beam 60 by means of machining the diaphragm top surface so as to form the metal beam 60. The beam 60 is formed to be substantially thicker than the uniformly flat area 80 defined by top surface 47 (and bottom surface 74) of diaphragm 70 outside of the beam area. Once the height of beam 60 is established by machining or milling the top surface of diaphragm 70 in area 80, one or more strain gages 15 are glass bonded to the top surface of beam 60 using methods well known to those of ordinary skill in the art of bonding glass to metal. Such glass bonding techniques utilize a glass frit and screen printing, firing and wire bonding processes, as known in the art, to provide strain gages formed on the beam and configured typically in a half or full Wheatstone Bridge configuration.

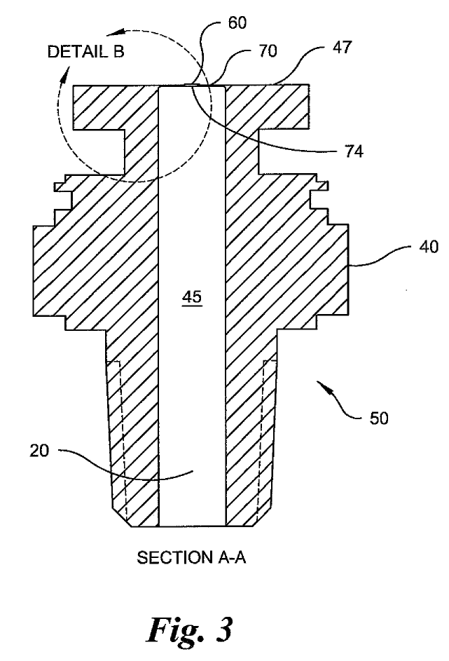

Referring to FIG. 3, there is shown a cross section of transducer 50 of FIG. 1 along the axis designated A-A. The axial hole 45 forms a pressure port 20 through a central axis of transducer 50. This allows pressure of a fluid within the port to be applied to the lower surface 74 of diaphragm 70. The pressure causes a flexure of metal diaphragm 70 that produces a strain on the beam 60. Flexure of beam 60 in turn produces a strain on the strain gages 15, which generate an electrical output indicative of the fluid pressure.

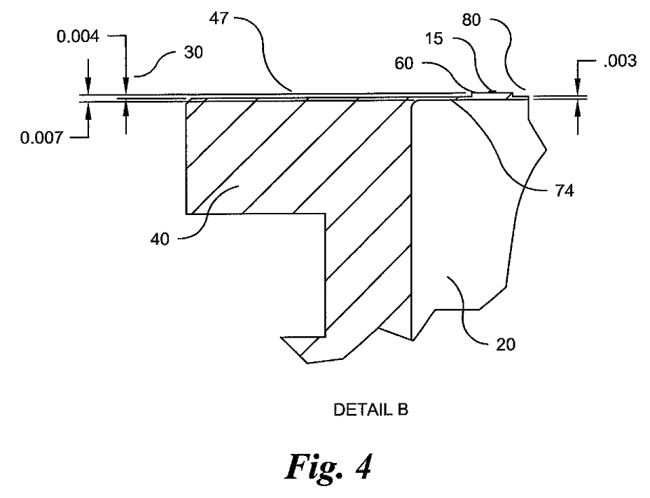

Referring to FIG. 4, there is shown a detailed view of area B of FIG. 3 according to an embodiment of the present invention. The area 80 of diaphragm 70 may be thinned to about 0.003 inch (in.). Beam 60 may be as thin as 0.007 in. to allow for stable strain gage reading on glass bonded silicon strain gages. In an exemplary embodiment, beam 60 may be 0.050 in. in width and may be produced by machining 0.004 in. off from the top surface of the initial thickness of diaphragm 70. The reduction in diaphragm thickness and the structure of the beam 60 (e.g. height, width and length) is obtained by milling or machining the metal diaphragm top surface to the desired dimensions. Such metal milling or machining is accomplished using standard machining tools for metal machining or via electrical discharge machining (EDM) via wire EDM, for example, as is known in the art.

The strain imposed on beam 60 from the applied pressure on the lower surface 74 of the diaphragm 70 is related to the ratio of the area 80 to the common area shared by the beam and the area 80. In one embodiment of the invention strain gages 15 measure strain levels in excess of three times those found in the prior art without the benefit of a raised beam, i.e., otherwise placed on the flat surface of area 80. The amplification produced by the effect of the ratio of metal beam 60 cross section and the area 80 of metal diaphragm 70 also results in greater accuracy when measuring low pressure in the range of 15 psi. The glass metal silicon portion interacts less, due in part to the thicker top portion of the beam, relative to the thin metal diaphragm part, as the beam part is relatively thicker, (e.g. two to three times the thickness). Additionally, beam 60 may be less susceptible to instability due to the strain induced due to the expansion coefficients between strain gages 15 and metal diaphragm 70.

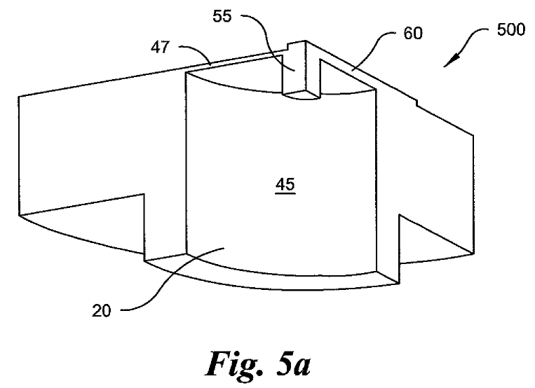

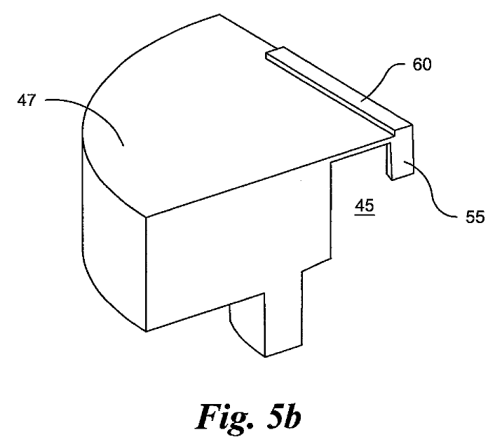

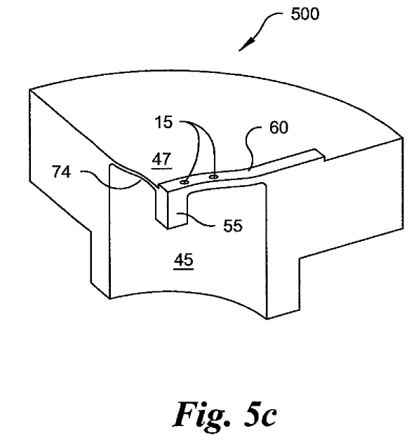

Referring now to FIGS. 5a, 5b, and 5c there are shown perspective quarter sectional views of an exemplary pressure port transducer 500 similar to that shown in FIGS. 1-4 but with a central boss 55 according to another embodiment of the invention. Like reference numerals have been used to indicate like parts. As seen in FIG. 5a-5c, metal beam 60 is monolithically integral to top surface 47 of diaphragm 70 which includes a central boss 55 extending therefrom into port 20 formed by axial bore hole 45. Strain gages (as seen in schematic form in FIG. 5c) are affixed to the top surface of beam 60 as previously discussed and as is known in the art. The present embodiment enables a monolithic structure of a very thin metal diaphragm to be sculpted to include a raised beam portion integral to the metal diaphragm and containing strain gages to provide an accurate low pressure transducer structure. The axial hole 45 forms the pressure port 20 through the central axis of the transducer 550, thereby allowing pressure within the port to be applied to the boss 55 of diaphragm 70. Flexure of diaphragm 70 produces a strain on the beam 60, which as best shown in FIG. 5c, produces a strain on the strain gages 15 by placing one or more in compression and/or tension to produce an electrical output indicative of the pressure. In an exemplary embodiment, two sets of strain gages are configured in an electrical circuit such as a Wheatstone Bridge arrangement so as to provide an electrical output corresponding to the applied pressure to appropriate receiver circuitry (not shown).

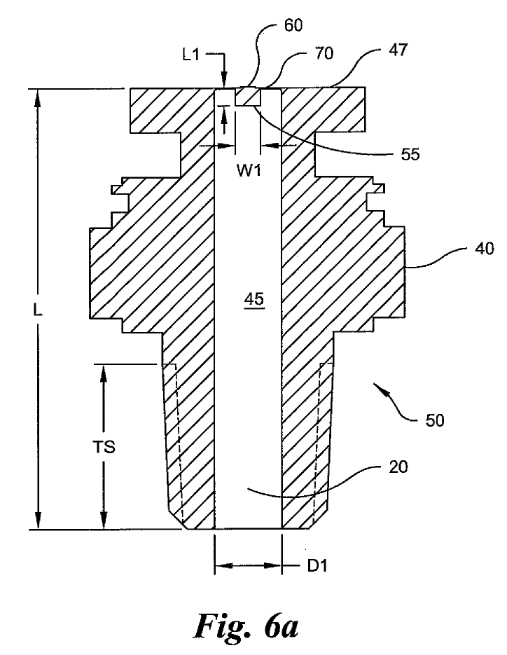

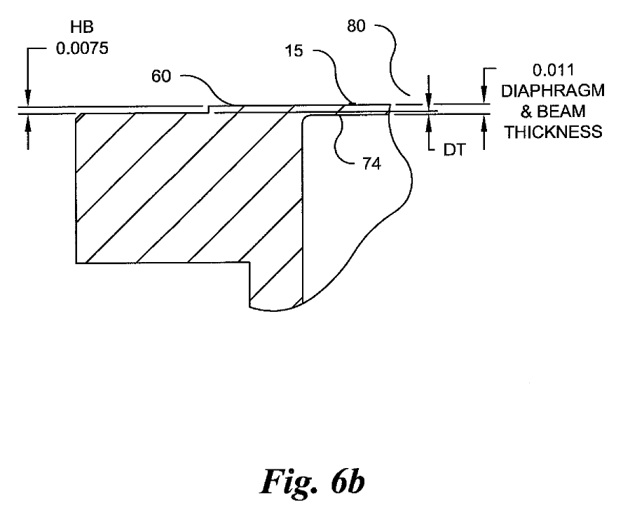

FIG. 6a illustrates a sectional view of a pressure port transducer having a bossed structure 55 as shown in FIG. 5a-5c and configured for low pressure (e.g. 15 PSI) measurement. As shown therein, the transducer has a length L of 1.427 in. and a threaded end section TS of 0.539 in. The central bore hole or port 20 has a diameter D1 of 0.316 in. Boss 55 extends monolithically from the center of lower surface 74 of metal diaphragm 70 a distance L1 of 0.048 in. and has a width W1 of 0.063 in. Beam 60 has a length LB of 0.500 in. and a width W of 0.050 in. As best shown in the detailed cross section view of FIG. 6B, the initial thickness of the diaphragm area 80 prior to reduction is 0.011 in. and after reduction is given as DT of 0.0035 in. The beam height HB (absent the thinned diaphragm thickness) is therefore 0.0075 in.

This embodiment may be achieved by means of machining the lower surface 74 of a metal diaphragm 70 to form the boss 55 and then further machining the top surface 47 of metal diaphragm 70 to form beam 60.

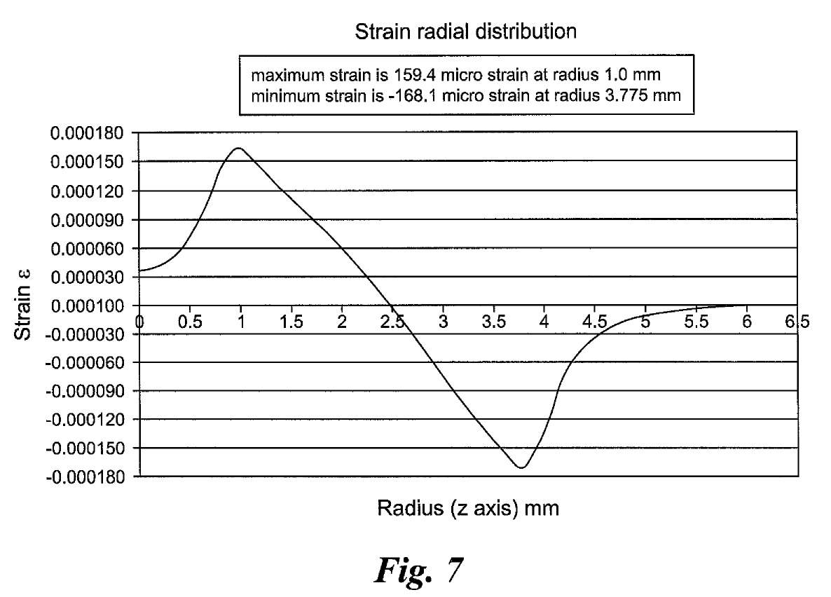

FIG. 7 shows a graph depicting strain radial distribution results associated with an embodiment of the present invention for a 15 PSI pressure port full beam transducer structure.

While the above discussion has included particular embodiments and details concerning implementation of the present invention, it is understand that the increase in strain level by using the raised beam integral to the diaphragm and boss structure depends on factors including beam and diaphragm dimensions. Higher strain levels allow for measurement of pressures several times smaller than those detectable with a flat diaphragm of sufficient thickness to avoid instability with temperature and pressure cycling. This allows pressure transducers to operate at lower pressures with substantially the same accuracy.

Furthermore, it is understood that pressure levels lower than 15 psi may be attainable if the diameter of the diaphragm is made larger, the web is made thinner, or the cross beam dimensions changed.

Thus, the present invention is embodied in a method for manufacturing a metal pressure transducer 50 including the steps of forming a thin metal cylindrical diaphragm 70 having operational plane top surface 47 and a lower surface 74; establishing a diameter and a thickness of the cylindrical diaphragm 70 relative to an operational plane by forming a hole 45 axially through the transducer 50 body that terminates at the lower surface 47; and machining the diaphragm top surface to create raised surface 60 in the shape of a cross beam integral to the operational surface 47; and glass bonding one or more strain gages 15 onto the cross beam. Machining the diaphragm or wafer structure 70 thins the diaphragm over substantially the entire active area with the exception of a very narrow or thin area defining the rectangular beam 60. A boss structure may be formed by machining the lower surface of the metal diaphragm a predetermined amount except for a central portion to form boss 55 as shown in FIGS. 5-6.

The single monolithic material structure formed comprises a metal such as stainless steel alloys, titanium, glass or ceramic. The strain gages may be formed from silicon or other semiconductor and may be attached to the beam 60 by any of the following methods such as glass bonding, epoxy bonding or anodic bonding. Such bonding techniques are known in the art and as such, a detailed description of these techniques is omitted here for brevity.

It will be apparent to those skilled in the art that modifications and variations may be made in the apparatus and process of the present invention without departing from the spirit or scope of the invention. It is intended that the present invention cover the modification and variations of this invention provided they come within the scope of the equivalents.

What is claimed is:

1. A method for manufacturing a low pressure transducer including the steps of:
forming in a metal transducer body a cylindrical metal diaphragm having a top surface and a lower surface;
establishing a diameter and a thickness of the cylindrical metal diaphragm relative to an operational plane by creating a hole axially positioned through the transducer body that terminates at the lower surface of the diaphragm;
reducing the thickness of the metal diaphragm from its top surface to form thereon a raised surface in the shape of a beam integral to the top surface of the diaphragm; and
glass bonding one or more strain gages to the raised surface of the metal beam.

2. The method of claim 1, wherein the reducing comprising machining.

3. The method of claim 2, wherein the machining comprises electric discharge machining (EDM).

4. The method of claim 1, further comprising forming a central boss structure on the lower surface of the diaphragm opposite the beam.

5. The method of claim 4, wherein the forming the central boss structure comprises reducing the thickness of the metal diaphragm from its lower surface to form a boss thereon.

6. The method of claim 1, wherein the beam thickness is greater than the diaphragm thickness.

7. The method of claim 1, wherein the beam thickness is greater than twice the diaphragm thickness.

8. The method of claim 5, wherein the boss has a thickness between that of the beam thickness and the diaphragm thickness.

9. The method of claim 1, wherein said strain gages are silicon strain gages.

10. A low-pressure fluid transducer comprising:
a metal body having a central bore defining a port for conveying a fluid pressure, the port terminating at an aft end of the body via a cylindrical metal diaphragm to which fluid pressure is applied, the metal diaphragm top surface having thereon a raised metal beam integral with the diaphragm and that crosses the diaphragm top surface;
at least one silicon strain gage glass bonded to a top surface of the raised metal beam, wherein the fluid pressure applied to the diaphragm lower surface deflects the diaphragm, producing a strain on the raised metal beam and the associated stain gage, thereby producing an electrical output indicative of the fluid pressure.

11. The transducer of claim 10, wherein the metal beam thickness is greater than the diaphragm thickness.

12. The transducer of claim 10, wherein the beam thickness is greater than twice the diaphragm thickness.

13. The transducer of claim 10, wherein the strain gages are silicon strain gages.

14. The transducer of claim 10, further comprising a central boss monolithically formed on the lower surface of the diaphragm opposite the beam.

15. The transducer of claim 14, wherein the boss has a thickness between the beam thickness and the diaphragm thickness.

16. The transducer of claim 10, wherein the metal diaphragm is stainless steel.

17. The transducer of claim 16, wherein the metal diaphragm has a thickness of 0.0035 inch, and wherein the metal beam has a thickness of 0.075 inch.

18. The transducer of claim 16, wherein a central boss monolithically formed on the lower surface of the diaphragm opposite the beam has a thickness of 0.063 inch.
